(19) United States
(12) Patent Application Publication
(10) Pub. No.: US 2021/0227401 A1
(43) Pub. Date: Jul. 22, 2021

(54) Service Layer Events in IMS

(71) Applicant: Telefonaktiebolaget LM Ericsson (publ), Stockholm (SE)

(72) Inventors: Emiliano Merino Vazquez, Leganés, Madrid (ES); Miguel Francisco CARRETERO GOMEZ, Tres Cantos (ES); Jose Miguel DOPICO SANJUAN, Torrelodones (Madrid) (ES); Fernando SELMA MARTIN, Valencia (ES)

(21) Appl. No.: 16/310,977

(22) PCT Filed: Jun. 29, 2016
(86) PCT No.: PCT/EP2016/065160

§ 371 Date: Dec. 18, 2018

(51) Int. Cl. H04W 24/02; H04W 60/02; H04W 60/06; H04W 24/08; H04L 12/26; H04L 29/06

(52) U.S. Cl. CPC H04W 24/02; H04W 60/02; H04W 60/06; H04L 65/1016; H04L 43/0817; H04L 65/1063; H04W 24/08

(57) ABSTRACT

Methods and apparatus for implementation of an Application Sever, AS, (300), a Serving Call Session Control Function, S-CSCF, (200) and a Home Subscriber Server, HSS, (100) in an Internet Protocol Multimedia Subsystem, IMS. A service monitor (318) of the AS monitors usage by one or more user equipments, UE, of one or more services offered in the IMS and an event manager (320) triggers an event, based on the monitored usage, the event comprising an update on at least one of a network operation and a UE operation for the one or more UEs in the IMS. The event manager controls a transmitter (302) to transmit an event notification to the S-CSCF, the event notification including the update on the at least one of a network operation and a UE operation. A registration manager (220) of the S-CSCF triggers an adaptation of the at least one of the network operation and the UE operation based on the received event notification.

### TECHNICAL FIELD

The invention is related to Quality of Service (QoS) in an Internet Protocol (IP) Multimedia Subsystem (IMS). The invention may relate to dynamic adaptation of QoS in an IMS based on activity and service utilization of a UE.

### BACKGROUND

When network dimensioning is to be undertaken for an IMS network (typically involving an Access Transfer Control Function (ATCF), a Call Session Control Function (CSCF), a Home Subscriber Server (HSS) and a Multimedia Telephony Application Server (MTAS)), an analysis is done based on the number of users, the services subscribed to by each user, the type of users (e.g. mobile, fixed, enterprise), the access used (e.g. wireless, 4G, WiFi), etc.

This results in an estimated amount of hardware required taking into account the traffic foreseen to be handled, e.g. transactions per second (TPS) in the HSS node at regular or busy hours. This estimation of hardware requirement may result in an estimated number of HSSs or MTASs needed to cope with all the traffic.

The use of proactive configuration and estimation in the Internet Protocol Multimedia Subsystem (IMS) network has a significant limitation that is currently the source of many complaints by operators when deciding to invest in new hardware and/or software licenses (typically based on the number of provisioned users). This is basically that the estimations are inaccurate and result in large amounts of resources being made available unnecessarily.

### SUMMARY

Aspects of the invention are aimed at mitigating and/or solving one or more problems associated with the prior art.

According to an aspect of the invention, there is provided a network node for use as an Application Sever, AS, in an Internet Protocol Multimedia Subsystem, IMS. The network node comprises a service monitoring means, which may be a service monitor, configured to monitor usage by one or more user equipments, UE, of one or more services offered in the IMS. The network node comprises an event managing means, which may be an event manager, configured to trigger an event, based on the monitored usage, the event comprising an update on at least one of a network operation and a UE operation for the one or more UEs in the IMS. The event manager is further configured to control a transmitter to transmit an event notification to a Serving Call Session Control Function, S-CSCF, the event notification including the update on the at least one of a network operation and a UE operation.

Optionally, the update is an update for registration of the one or more UEs and comprises an update to a timer for re-registration of the one or more UEs in the IMS network.

Optionally, the event manager is configured to trigger the event if the one or more UEs has not used a service amongst the one or more services for a period of time exceeding a threshold value.

Optionally, the network node further comprises a receiving means, which may be a receiver, configured to receive a further event notification from the S-CSCF, wherein the further event notification comprises a network parameter relating to an IMS Core Network, IMS CN, and wherein the event manager is configured to trigger the event based on the network parameter and the monitored usage.

Optionally, the network parameter relating to the IMS CN indicates a memory utilization within the IMS CN.

Optionally, the update is an update for registration of the one or more UEs and comprises a de-registration of the one or more UEs from the IMS.

Optionally, a receiver is configured to receive a subscription request from the S-CSCF, the subscription request comprising one or more subscriptions to respective one or more events supported by the S-CSCF, the network node further comprising a subscription managing means, which may be a subscription manager, configured to set up a subscription for the S-CSCF to be notified if an event amongst the one or more supported events occurs.

According to a further aspect of the invention, there is provided a method for operating a network node for use as an Application Sever, AS, in an Internet Protocol Multimedia Subsystem, IMS. The method comprises monitoring, by a service monitor, usage by one or more user equipments, UE, of one or more services offered in the IMS. The method comprises triggering, by an event manager, an event, based on the monitored usage, the event comprising an update on at least one of a network operation and a UE operation for the one or more UEs in the IMS. The method comprises controlling, by the event manger, a transmitter to transmit an event notification to a Serving Call Session Control Function, S-CSCF, the event notification including the update on the at least one of a network operation and a UE operation.

Optionally, the update is an update for registration of the one or more UEs and comprises an update to a timer for re-registration of the one or more UEs in the IMS network.

Optionally, the event manager triggers the event if the one or more UEs has not used a service amongst the one or more services for a period of time exceeding a threshold value.

Optionally, the method further comprises receiving, by a receiver, a further event notification from the S-CSCF, wherein the further event notification comprises a network parameter relating to an IMS Core Network, IMS CN; and triggering, by the event manager, the event based on the network parameter and the monitored usage.

Optionally, the network parameter relating to the IMS CN indicates a memory utilization within the IMS CN.

Optionally, the update is an update for registration of the one or more UEs and comprises a de-registration of the one or more UEs from the IMS.

Optionally, the method further comprises receiving, by a receiver, a subscription request from the S-CSCF, the subscription request comprising one or more subscriptions to respective one or more events supported by the S-CSCF; and setting up, by a subscription manager, a subscription for the S-CSCF to be notified if an event amongst the one or more supported events occurs.

According to a further aspect of the invention, there is provided a network node for use as a Serving Call Session Control Function, S-CSCF, in an Internet Protocol Multimedia Subsystem, IMS. The network node comprises a receiving means, which may be a receiver, configured to receive from an Application Server, AS, an event notification comprising an update on at least one of a network operation and a UE operation for one or more UEs in the IMS, wherein the update is based on a usage by the one or more UEs of a service amongst one or more services offered in the IMS. The network node further comprises a registration managing means, which may be a registration manager, configured to trigger an adaptation of the at least one of the network operation and the UE operation based on the received event notification.

Optionally, the update is an update for registration of the one or more UEs and comprises an update to a re-registration timer for re-registration of the one or more UEs in the IMS network, and wherein the registration manager is configured to update the re-registration timer.

Optionally, the registration manager is configured to control a transmitter to transmit a message towards the one or more UEs, the message for triggering a re-registration request by the one or more UEs for re-registering the one or more UEs in the IMS, wherein the receiver is configured to receive a re-registration request originating from the one or more UEs, and wherein the registration manager is configured to set a new re-registration timer according to the update of the re-registration timer in the event notification and to control a transmitter to transmit a message towards the one or more UEs indicating the new re-registration timer.

Optionally, the network node further comprises a network parameter managing means, which may be a network parameter manager, configured to monitor a network parameter related to an IMS Core Network, IMS CN, and configured to control a transmitter to transmit a further event notification to the AS in dependence on the monitored network parameter meeting one or more criteria, wherein the further event notification comprises data indicating the monitored network parameter.

Optionally, the monitored network parameter indicates a memory utilization in the IMS, and wherein the network parameter manager is configured to control the transmitter to transmit the further event notification if the memory utilization rises above a threshold value.

Optionally, the update is an update for registration of the one or more UEs in the IMS and comprises a de-registration of the one or more UEs, and wherein the registration manager is configured to de-register the one or more UEs from the IMS.

Optionally, the network node further comprises an event checking means, which may be an event checker, configured to control a transmitter to transmit to a Home Subscriber Server, HSS, a request for event data corresponding to an AS, wherein the receiver is configured to receive the event data from the HSS, the event data identifying one or more events supported by the AS, and the network node further comprising an event subscriber configured to control the transmitter to transmit a subscription request to the AS, the subscription request comprising one or more subscriptions to the respective one or more events supported by the AS.

According to a further aspect of the invention, there is provided a method for operating a network node for use as a Serving Call Session Control Function, S-CSCF, in an Internet Protocol Multimedia Subsystem, IMS. The method comprises receiving, by a receiver from an Application Server, AS, an event notification comprising an update on at least one of a network operation and a UE operation for one or more UEs in the IMS, wherein the update is based on a usage by the one or more UEs of a service amongst one or more services offered in the IMS. The method comprises triggering, by a registration manager, an adaptation of the at least one of the network operation and the UE operation based on the received event notification.

Optionally, the update is an update for registration of the one or more UEs and comprises an update to a re-registration timer for re-registration of the one or more UEs in the IMS network, and further comprising updating, by the registration manager, the re-registration timer.

Optionally, the method further comprises controlling, by the registration manager, a transmitter to transmit a message towards the one or more UEs, the message for triggering a re-registration request by the one or more UEs in the IMS; receiving, by the receiver, a re-registration request originating from the one or more UEs; setting, by the registration manager, a new re-registration timer according to the update of the re-registration timer in the event notification; and controlling, by the registration manager, a transmitter to transmit a message towards the one or more UEs indicating the new re-registration timer.

Optionally, the method further comprises monitoring, by a network parameter manager, a network parameter related to an IMS Core Network, IMS CN; and controlling, by the network parameter manager, a transmitter to transmit a further event notification to the AS in dependence on the monitored network parameter meeting one or more criteria, wherein the further event notification comprises data indicating the monitored network parameter.

Optionally, the monitored network parameter indicates a memory utilization in the IMS, and further comprising controlling, by the network parameter manager, the transmitter to transmit the further event notification if the memory utilization rises above a threshold value.

Optionally, the update is an update for registration of the one or more UEs in the IMS and comprises a de-registration of the one or more UEs, and further comprising de-registering, by the registration manager, the one or more UEs from the IMS.

Optionally, the method further comprises controlling, by an event checker, a transmitter to transmit to a Home Subscriber Server, HSS, a request for event data corresponding to an AS; receiving, by the receiver, the event data from the HSS, the event data identifying one or more events supported by the AS; and controlling, by an event subscriber, the transmitter to transmit a subscription request to the AS, the subscription request comprising one or more subscriptions to the respective one or more events supported by the AS.

According to a further aspect of the invention, there is provided a network node for use as a Home Subscriber Server, HSS, in an Internet Protocol Multimedia Subsystem, IMS. The network node comprises a receiving means, which may be a receiver, configured to receive from a Serving Call Session Control Function, S-CSCF, a request for event data for an Application Server, AS, in the IMS, the event data identifying one or more events supported by the AS. The network node comprises an event managing means, which may be an event data manager, configured to determine the event data based on the received request and to control a transmitter to transmit the determined event data to the S-CSCF.

Optionally, the event data manager is configured to identify the one or more events supported by the AS from a list of events stored in the network node per AS basis.

According to a further aspect of the invention, there is provided a method operating a network node for use as a Home Subscriber Server, HSS, in an Internet Protocol Multimedia Subsystem, IMS. The method comprises receiving, by a receiver from a Serving Call Session Control Function, S-CSCF, a request for event data for an Application Server, AS, in the IMS, the event data identifying one or more events supported by the AS. The method comprises determining, by an event data manager, the event data based on the received request. The method comprises controlling, by the event data manager, a transmitter to transmit the determined event data to the S-CSCF.

Optionally, the event data manager, the one or more events supported by the AS is carried out from a list of events stored in the network node per AS basis.

According to further aspects of the invention, there is provided a computer program comprising instructions which, when executed on at least one processor, cause the at least one processor to carry out any method disclosed above or anywhere else herein.

According to further aspects of the invention, there is provided a carrier containing the computer program disclosed above, wherein the carrier is one of an electronic signal, optical signal, radio signal, or non-transitory computer readable storage medium.

### BRIEF DESCRIPTION OF THE DRAWINGS

Exemplary embodiments of the invention are described herein with reference to the accompanying drawings, in which:

FIG. 1 is a block schematic representation of a HSS;

FIG. 2 is a block schematic representation of a S-CSCF;

FIG. 3 is a block schematic representation of an IMS AS;

FIG. 4 is a signaling diagram showing an exemplary initial registration and subscription to service layer events;

FIG. 5 is a signaling diagram showing the notification of an event from a service layer to an IMS core network;

FIG. 6 is a signaling diagram showing notification of an event from an IMS core network to a service layer; and

FIG. 7 is a signaling diagram showing signaling after failover to a secondary application server.

### DETAILED DESCRIPTION

Methods and apparatus disclosed herein propose the concept of an IMS Core Network subscribing to Service Layer (SL) (or Application Server (AS)) events so that at any given time, for a given user (or plurality of users) an AS can notify the core network about certain events (e.g. an increase in the re-registration timer or a change of access type e.g. 4G/WiFi). These events may indicate to nodes of an IMS Core Network (IMS CN), in particular the CSCF, or to other ASs, events occurring in other services/ASs and associated with a user. Additionally, certain events can also be used by the IMS CN nodes to notify the IMS SL nodes about a potential network mismatch (e.g. the CSCF performing failback towards a primary AS after a failover).

The methods and apparatus disclosed herein may be configured such that the HSS can indicate to the S-CSCF which as support the feature, and at the same time which events are supported and authorized by the ASs. This information may be provided to the S-CSCF as part of a user profile or Initial Filter Criteria (IFC) at initial IMS registration.

The inventors have appreciated that different users access IMS services with different frequencies. In existing methods and apparatus, if a user sends multimedia messages very often, for network dimensioning this user has the same treatment as if the user seldom uses such services. A brief example taken from operators' operations is given below.

a) an operator provides a supplier with the estimation of users foreseen to be subscribed to a Rich Communication Service (RCS).

b) the supplier determines and provides to the operator the estimated amount of hardware required (e.g. 20 HSSs) to cope with the estimated TPS. The supplier realized that 80% of the TPSs are due to IMS re-registrations and only 20% for the traffic derived from the users' activity.

IMS re-registrations can be due to normal registration refresh or due to a change of access type or a new IP allocated for a user equipment (UE) or SIP terminal. Typical IMS re-registration occurs every half an hour since this is directly related to the end user experience (quality of service). Therefore, if the IMS network takes a long time to be aware when the user is reachable or unreachable, the service experience will be downgraded (e.g. multimedia messages may be placed in a message waiting list for too long).

Operators are reluctant to deploy such a high number of HSSs just to offer the service to all users even though many of them will not use it at all (at least initially). It is noted that many IMS services can by default be installed in a smartphone but this does not necessarily mean that a user will actively use those services. Therefore, the user may be registered in the IMS (and consuming resources) for a very long period without requiring any service to be provided.

Currently, only the core network layer can apply certain parameters applicable to all users equally, and based on pre-configured information. The inventors have appreciated that there is no functionality for the SL to dictate how the core network should behave for one or more users not requiring the same level of resources.

A list of SIP events is defined by the Internet Assigned Number Authority (IANA). Some of those SIP events are commonly used for services and network events, e.g.:
Presence (used to know a user's status, e.g. offline);
Reg (used to inform when a user is de-registered by the network); and
Conference (used by a conference service to alert conference participants whenever a new participant joins the conference).

The methods and apparatus disclosed herein introduce and make use of a number of new events that may be signaled from the IMS SL towards the IMS CN layer or in the opposite direction. The new events include:
de-registration initiated by AS (from IMS SL towards the IMS CN)
re-registration timer adjusted (from IMS SL towards IMS CN)
AS failback (from IMS CN towards IMS SL)
memory-usage threshold reached (from IMS CN towards IMS SL)
access-type-change (from IMS SL towards IMS CN)

Methods and apparatus disclosed herein may provide one or more of the following advantages over the prior art.
Efficient utilization of network resources based on a frequency of service usage by a user.
Dynamic adaptation of a network initiated by the SL (instead of configuration-based) to provide a better quality of experience for subscribers making a large use of specific services.
Helping future virtualized network functions (VNF) to quickly adapt to a traffic increase without the need for re-configuring/re-balancing the network based on traffic activities.

Methods and apparatus disclosed herein may modify existing procedures in several aspects, some of which are mentioned below.

a) Initial registration and/or subscription to SL events

When registration is accepted and the SL is informed (e.g. an AS is notified via 3^{rd} party registration), the CSCF may subscribe to service events supported by the AS (as indicated in user profile from the HSS) so that at any given time for any given user (or a plurality of users) the SL notifies the IMS CN about any event change.

b) Upon a change in certain (and likely dynamic) aspects of a user's usage of a service, the AS may decide to notify the IMS CN about an event which may cause the IMS CN (e.g. the S-CSCF or the P-CSCF) to act upon it (e.g. to increase the re-registration timer in order to decrease overall signaling in the network).

c) The IMS CN may notify the AS (possibly under a dialog/subscription initiated previously) about events (e.g. the CSCF memory utilization is becoming too high) so that the AS can also act upon it, e.g. by notifying about users that can be de-registered from the network because the last traffic activity for certain (or a plurality of) users occurred a long time ago and they are unlikely to become aware of a temporary lack of the service.

d) Some advanced Operation and Maintenance (O&M) procedures can be available to the operator due to other conditions, e.g. if the IMS Access Point Name (APN) has a temporary shortage of IP addresses, or the current number of IMS radio bearers established is too high, the operator can decide to free some resources by simply initiating a notification of an event towards the SL (or AS) so that the SL may determine (e.g. based on service utilization or any other algorithm) one or more users (and/or bearers) that may be released with minimum impact on other users making use of services.

Methods and apparatus disclosed herein describe that an IMS network may be dynamically adjusted/balanced based on the service utilization by one or more users, rather than only based on pre-configured information about access type, type of device, etc. Methods and apparatus disclosed herein may also provide a generic mechanism for the IMS CN and SL to notify each other about other network events (e.g. AS failback).

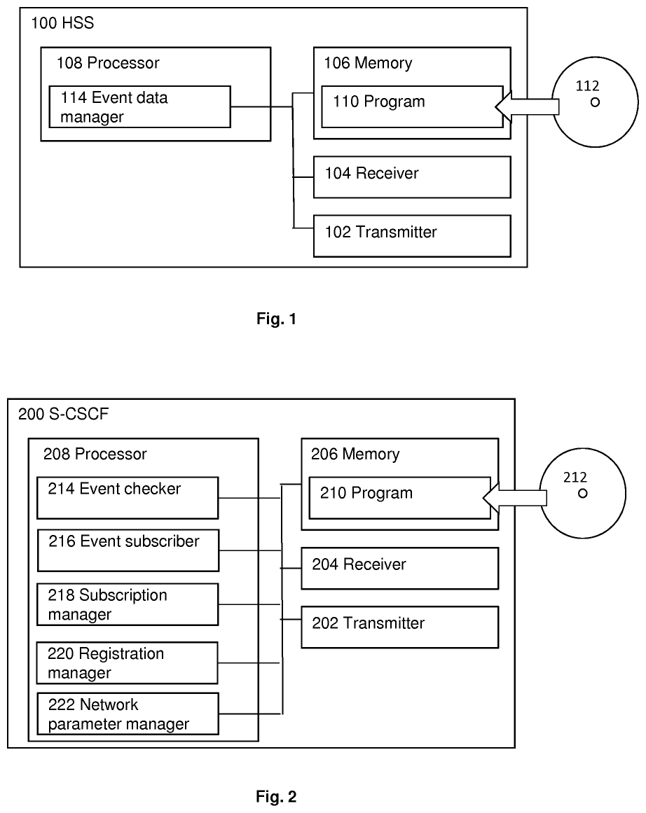

FIG. 1 shows a schematic representation of a network node for implementing a HSS 100. The HSS 100 comprises a transmitter 102 and a receiver 104. The transmitter 102 and receiver 104 may be in data communication with other network entities in a telecommunications network and are configured to transmit and receive data accordingly.

The HSS 100 further comprises a memory 106 and a processor 108. The memory 106 may comprise a non-volatile memory and/or a volatile memory. The memory 106 may have a computer program 110 stored therein. The computer program 110 may be configured to undertake the methods disclosed herein. The computer program 110 may be loaded in the memory 106 from a non-transitory computer readable medium 112, on which the computer program is stored. The processor 108 is configured to undertake at least the function of event data manager 114, as set out below.

Each of the transmitter 102 and receiver 104, memory 106, processor 108 and event data manager 114 is in data communication with the other features 102, 104, 106, 108, 110, 114 of the HSS 100. The HSS 100 can be implemented as a combination of computer hardware and software. In particular, the event data manager 114 may be implemented as software configured to run on the processor 108, or as a combination of hardware and software in a separate module. The memory 106 stores the various programs/executable files that are implemented by a processor 108, and also provides a storage unit for any required data. The programs/executable files stored in the memory 106, and implemented by the processor 108, can include the event data manager 114, but are not limited to such.

FIG. 2 shows a schematic representation of a network node for implementing a S-CSCF 200. The S-CSCF 200 comprises a transmitter 202 and a receiver 204. The transmitter 202 and receiver 204 may be in data communication with other network entities in a telecommunications network and are configured to transmit and receive data accordingly.

The S-CSCF 200 further comprises a memory 206 and a processor 208. The memory 206 may comprise a non-volatile memory and/or a volatile memory. The memory 206 may have a computer program 210 stored therein. The computer program 210 may be configured to undertake the methods disclosed herein. The computer program 210 may be loaded in the memory 206 from a non-transitory computer readable medium 212, on which the computer program is stored. The processor 208 is configured to undertake one or more of the functions of an event checker 214, an event subscriber 216, a subscription manager 218, a registration manager 220 and a network parameter manager 222, as set out below.

Each of the transmitter 202 and receiver 204, memory 206, processor 208, event checker 214, event subscriber 216, subscription manager 218, registration manager 220 and network parameter manager 222 is in data communication with the other features 202, 204, 206, 208, 210, 214, 216, 218, 220, 222 of the S-CSCF 200. The S-CSCF 200 can be implemented as a combination of computer hardware and software. In particular, the event checker 214, event subscriber 216, subscription manager 218, registration manager 220 and network parameter manager 222 may be implemented as software configured to run on the processor 208, or as combinations of hardware and software in separate modules. The memory 206 stores the various programs/executable files that are implemented by a processor 208, and also provides a storage unit for any required data. The programs/executable files stored in the memory 206, and implemented by the processor 208, can include the event checker 214, event subscriber 216, subscription manager 218, registration manager 220 and network parameter manager 222, but are not limited to such.

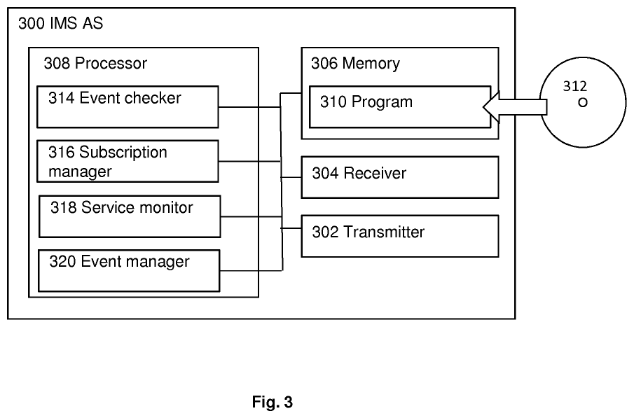

FIG. 3 shows a schematic representation of a network node for implementing an IMS-AS 300. The IMS-AS 300 comprises a transmitter 302 and a receiver 304. The transmitter 302 and receiver 304 may be in data communication with other network entities in a telecommunications network and are configured to transmit and receive data accordingly.

The IMS-AS 300 further comprises a memory 306 and a processor 308. The memory 306 may comprise a non-volatile memory and/or a volatile memory. The memory 306 may have a computer program 310 stored therein. The computer program 310 may be configured to undertake the methods disclosed herein. The computer program 310 may be loaded in the memory 306 from a non-transitory computer readable medium 312, on which the computer program is stored. The processor 308 is configured to undertake one or more of the functions of an event checker 314, a subscription manager 316, a service monitor 318 and an event manager 320, as set out below.

Each of the transmitter 302 and receiver 304, memory 306, processor 308, event checker 314, subscription manager 316, service monitor 318 and event manager 320 is in data communication with the other features 302, 304, 306, 308, 310, 314, 316, 318, 320 of the IMS-AS 300. The IMS-AS 300 can be implemented as a combination of computer hardware and software. In particular, the event checker 314, subscription manager 316, service monitor 318 and event manager 320 may be implemented as software configured to run on the processor 308, or as combinations of hardware and software in separate modules. The memory 306 stores the various programs/executable files that are implemented by a processor 308, and also provides a storage unit for any required data. The programs/executable files stored in the memory 306, and implemented by the processor 308, can include the event checker 314, subscription manager 316, service monitor 318 and event manager 320, but are not limited to such.

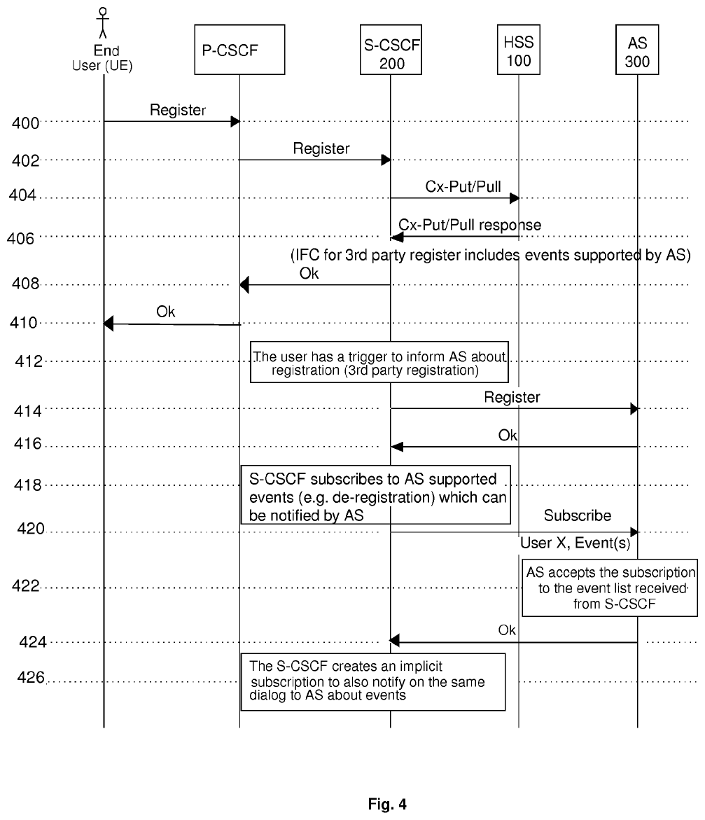

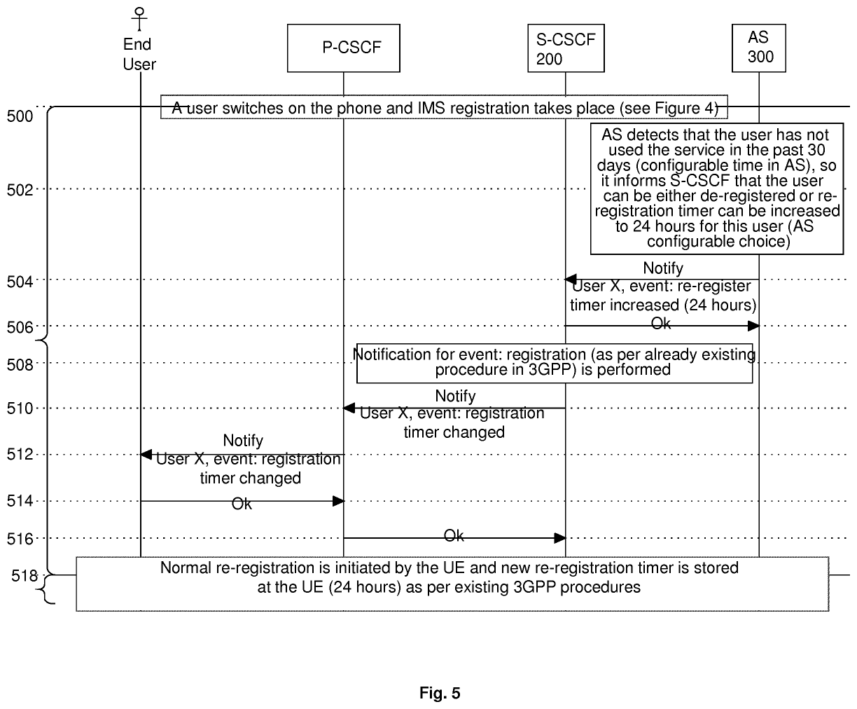

FIG. 4 is a signaling diagram showing an exemplary initial registration and subscription to SL events.

400-404. A user equipment (UE) registers in the IMS. At step 404, the event checker 214 of the S-CSCF 200 controls the transmitter 202 to transmit a request to the HSS 100 requesting event data corresponding to an AS 300. The request may, for example, request a user profile relating to a user of the UE and containing Initial Filter Criteria (IFC) specifying the event data. The event data identifies the events that may be subscribed to for (i.e. are supported by) the AS 300.

406. The event data manger 114 of the HSS 100 transmits the event data to the S-CSCF 200. As mentioned above, the event data may be part of a user profile that includes IFC for third party registration. The IFC contain a list of events supported by the AS 300, as configured by the operator.

408-416. Registration (and third party registration towards the AS 300) is completed as normal.

418. Based on the event data received from the HSS 100, the event checker 214 of the S-CSCF 200 checks whether the events supported by and authorized for the AS 300 are supported (and enabled) in the S-CSCF 200. The event data may comprise events that are monitored by the AS 300 and are notified to the S-CSCF 200 and/or events that are monitored by the S-CSCF 200 and are notified to the AS 300, as discussed herein.

420. If at least one event identified in the event data received from the HSS 100 is supported in the S-CSCF 200, the event subscriber 216 of the S-CSCF 200 controls the transmitter 202 to transmit to the AS 300 a subscription request to subscribe to the at least one event. The transmitted subscription request may be an SIP SUBSCRIBE message.

It is noted that the at least one event subscribed to by the event subscriber 216 of the S-CSCF 200 and included in the subscription request might contain one, several or all events supported by the AS 300 and received in the event data from the HSS 100. In exemplary arrangements, the events subscribed to are limited to those identified in the event data received from the HSS 100, for example in the IFC. This may be the case even if there are additional events locally supported in S-CSCF 200.

422. The event checker 314 of the AS 300 checks whether all events received in the subscription request from the S-CSCF 200 are supported by the AS 300. It is assumed in this example that IFCs are properly configured by the operator and the events selected by the S-CSCF 200 are all supported in AS 300. The subscription manager 316 of the AS 300 accepts the subscription request, which may be based on the result of the event check.

424. The subscription manager 316 controls the transmitter 302 to transmit a successful response to the S-CSCF 200. The successful response may be a SIP 200 OK message.

426. The receiver 204 of the S-CSCF 200 receives the successful response transmitted by the AS 300, and the subscription manager 218 of the S-CSCF 200 creates an implicit subscription in order to be able to notify (or receive notifications) for the events subscribed to using the same SIP dialog (created in steps 420 to 424). The implicit subscription may comprise a subscription for the AS 300 to notifications in respect of events monitored by the CSCF, such as when memory utilization in the S-CSCF is above a threshold.

At this point, both the AS 300 and the S-CSCF 200 know the events supported by each other, i.e. the AS 300 stores the events supported by S-CSCF 200 from those events included in the subscription request, and the S-CSCF 200 stores the same events it previously selected among those received from the HSS 100 when building the implicit subscription request, given that the AS 300 accepted the subscription.

FIG. 5 is a signaling diagram showing the notification of an event from the SL (the AS 300) to the IMS CN (the S-CSCF and/or the P-CSCF).

500. IMS registration takes place as described above with reference to FIG. 4. The S-CSCF and AS 300 then have an active subscription for supported events as defined in the event data (e.g. the IFC) stored in and provided by the HSS 100.

502. The service monitor 318 of the AS 300 monitors the usage by the UE of one or more services offered in the IMS. The event manager 320 may trigger an event if the monitored usage meets one or more criteria. In the exemplary arrangement of FIG. 5, the service monitor 318 monitors the amount of time since a UE has accessed the one or more services. The network operator may have configured the event manager 320 of the AS 300, for example, to trigger an event to increase the re-registration timer (e.g. from one hour to 24 hours) for the UE if it has not accessed a service in a configured time (e.g. two weeks or 30 days).

504-506. If the amount of time since a UE has accessed the one or more services exceeds a threshold, the event manager 320 triggers an event and controls the transmitter 302 of the AS 300 to transmit an event notification to the S-CSCF 200 (e.g. via SIP NOTIFY). The notification may comprise data indicating an update for a registration of the UE. In this example, the notification comprises data notifying the S-CSCF 200 of an update to a re-registration timer for the UE. The XML body included in notification may include the new re-registration timer to be applied for the UE. Other types of event may also be monitored by the service monitor 318 and may be notified to the S-CSCF 200. The S-CSCF 200 responds to the AS 300 by transmitting an acknowledgement of the notification.

508-512. The receiver 204 of the S-CSCF 200 receives the event notification from the AS 300. The registration manager 220 of the S-CSCF 200 stores the update to the registration from the event notification in the memory 206. In the exemplary method, the update to the registration comprises an update to the re-registration timer determined by the AS 300. The registration manager 220 controls the transmitter 202 to transmit an event notification towards the UE via the P-CSCF. The event notification comprises data relating to the update for the registration, in this case data indicating that the re-registration timer has been shortened in order to force a new re-registration by the UE.

514-516. Upon receiving the event notification, the UE transmits a new registration request to the IMS via the P-CSCF (e.g. with a SIP register message), which has been triggered by the event notification. The new registration message includes the previous re-registration timer (e.g. 1 hour). The S-CSCF 200 receives the new registration request originating from the UE.

518. The registration manager 220 updates the re-registration timer to the new value included in the first event notification from the AS 300 to the S-CSCF 200, in this case 24 hours. The S-CSCF 200 transmits the updated re-registration timer to UE via the P-CSCF. The UE receives and stores the updated re-registration timer (24 hours). Future re-registrations by the UE will take place each 24 hours, instead of 1 hour, so that the network signaling is decreased substantially for this user since the network has adjusted it based on the user's service activity.

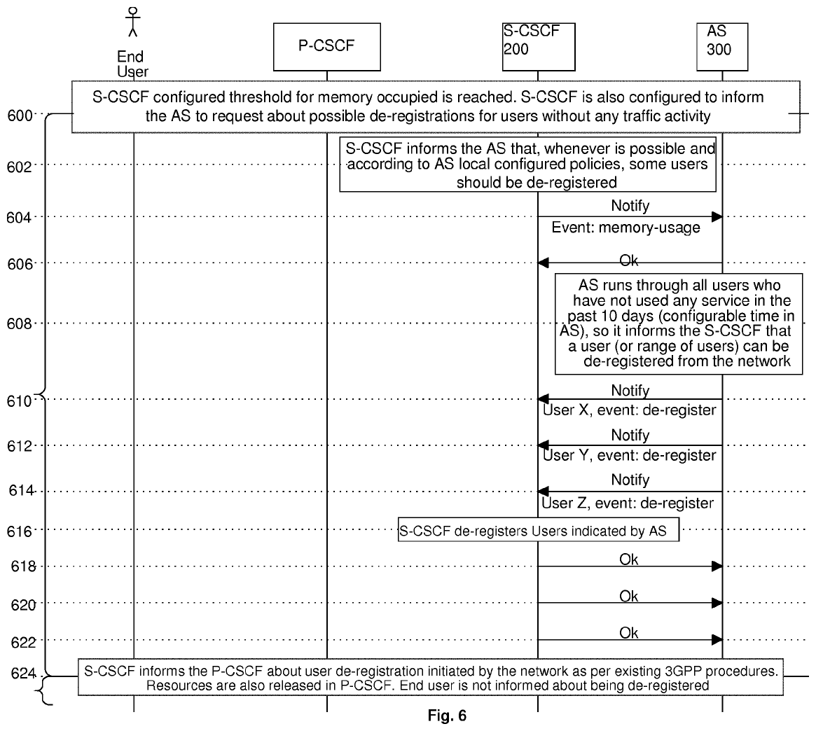

FIG. 6 is a signaling diagram showing the notification of an event from the IMS CN (e.g. the S-CSCF and/or the P-CSCF) to the SL (e.g. the AS 300).

600. In exemplary methods and apparatus, the operator may have configured the S-CSCF to monitor one or more network parameters, such as memory utilization.

602. The network parameter manager 222 monitors a network parameter, in this case memory utilization and determines whether it exceeds the threshold.

604-606. If the memory utilization reaches the threshold value (e.g. 75%), the network parameter manager 220 of the S-CSCF 200 controls the transmitter 202 to transmit an event notification to the AS 300. In this case, that the memory threshold has been reached (e.g. a virtualized S-CSCF informs the AS 300 about a memory shortage by using an event: memory-usage). The event notification may be transmitted over any SIP dialog/SIP subscription for any user. The XML body in the event notification may include the current memory utilization (e.g. 75%).

608. The service monitor 318 of the AS 300 monitors usage of one or more UEs. Based on the monitored usage and policy data, which may be pre-configured, identifying local policies for de-registration of users, the service monitor may determine network parameters relating to one or more UEs that may be updated in response to the event notification. For example, if the event notification identifies that memory utilization has exceeded the threshold, the service monitor 318 may determine that one or more UEs may be de-registered from the IMS. This frees up more memory. The one or more users may be de-registered, for example, if they have not been active for a period of time. In exemplary methods and apparatus, for 75% memory occupied, users which have not been active for 10 days might be immediately de-registered. The local policies may be by operator and implementation choice (e.g. another local policy can be the historical usage in the past months, i.e. how often the service is used).

610-614. The service monitor 318 of the AS 300 transmits an event notification to the S-CSCF 200 for each UE affected. The event notification may be transmitted using event: de-registration for selected users. This procedure may be applied by using configured throttling (e.g. notifying in bursts of 50 users).

616-622. The network parameter manager 220 of the S-CSCF 200 de-registers the notified users. The S-CSCF 200 transmits responses to the AS 300 notifying it that the UEs have been de-registered.

624. The S-CSCF 200 informs the P-CSCF about user de-registration initiated by the network as per existing 3GPP procedures. Resources are also released, thereby alleviating the problem of, in this case, excess memory usage. In exemplary methods and apparatus, instead of notifying the P-CSCF and UE about the registration(s) terminated by the network, which gives the UE a choice to initially register again, the S-CSCF 200 may transmit a notification to the P-CSCF only in order to release the resources also in P-CSCF and keeping the UE unregistered. The memory utilization is dynamically and gradually decreased and at the same time the recently active users are not impacted.

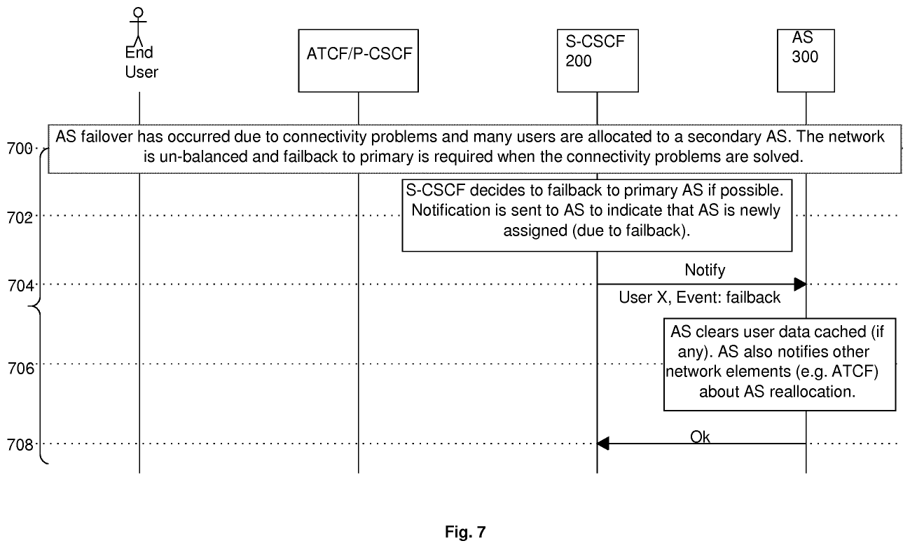

FIG. 7 is a signaling diagram showing signaling after failover to a secondary AS.

700. After a failover to a secondary AS (not shown in FIG. 7), the S-CSCF 200 is configured to failback to the primary AS 300 when the connectivity to the primary AS 300 has been recovered. The signaling shown in FIG. 7 may be undertaken when the primary AS 300 is selected again.

702. The primary AS 300 might have user data cached from when it was previously in use. Therefore, the network parameter manager 222 of the S-CSCF 200 determines that a failover has occurred before re-assigning the primary AS 300.

704. The network parameter manager 222 controls the transmitter 202 to transmit an event notification indicating that failback has occurred to the primary AS 300. This may be done with the event: failback.

706-708. The primary AS 300 removes all cached user data and fetches current user data from HSS 100 (in order to have the up-to-date copy of user data). In addition, other network elements (such as an access transfer control function, ATCF, for a single radio voice call continuity, SRVCC) are informed about the newly assigned primary AS 300 (identified by an access transfer update, ATU,—session transfer identifier, STI, for SRVCC). The network status is then consistent and failback is completed.

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The skilled person will be able to envisage other embodiments without departing from the scope of the appended claims.

1. A network node for use as an Application Sever, AS, in an Internet Protocol Multimedia Subsystem, IMS, the network node comprising:
a service monitor configured to monitor usage by one or more user equipments, UE, of one or more services offered in the IMS; and
an event manager configured to trigger an event, based on the monitored usage, the event comprising an update on at toast one of a network operation and a UE operation for the one or more UEs in the IMS,
wherein the event manager is further configured to control a transmitter to transmit an event notification to a Serving Call Session Control Function, S-CSCFV, the event notification including the update on the at least one of a network operation and a UE operation.

2. A network node according to claim 1, wherein the update is an update for registration of the one or more UEs and comprises an update to a timer for re-registration of the one or more UEs in the IMS network.

3. A network node according to claim 1, wherein the event manager is configured to trigger the event if the one or more UEs has not used a service amongst the one or more services for a period of time exceeding a threshold value.

4. A network node according to claim 1 further comprising a receiver configured to receive a further event notification from the S-CSCF, wherein the further event notification comprises a network parameter relating to an IMS Core Network, IMS CN,
and wherein the event manager is configured to trigger the event based on the network parameter and the monitored usage.

5. A network node according to claim 4, wherein the network parameter relating to the IMS CN indicates a memory utilization within the IMS CN.

6. A network node according to claim 5, wherein the update is an update for registration of the one or more UEs and comprises a de-registration of the one or more UEs from the IMS.

7. A network node according to any preceding claim 1, wherein a receiver is configured to receive a subscription request from the S-CSCF, the subscription request comprising one or more subscriptions to respective one or more events supported by the S-CSCF;
and further comprising a subscription manager configured to set up a subscription for the S-CSCF to be notified if an event amongst the one or more supported events occurs.

8. A method for operating a network node for use as an Application Sever, AS, in an Internet Protocol Multimedia Subsystem, IMS, the method comprising:
monitoring, by a service monitor, usage by one or more user equipments, UE, of one or more services offered in the IMS;
triggering, by an event manager, an event, based on the monitored usage, the event comprising an update on at least one of a network operation and a UE operation for the one or more UEs in the IMS; and
controlling, by the event manger, a transmitter to transmit an event notification to a Serving Call Session Control Function, S-CSCF, the event notification including the update on the at least one of a network operation and a UE operation.

9. A method according to claim 8, wherein the update is an update for registration of the one or more URs and comprises an update to a timer for re-registration of the one or more UEs in the IMS network.

10. A method according to claim 8, wherein the event manager triggers the event if die one or more UEs has not used a service amongst the one or more services for a period of time exceeding a threshold value.

11. A method according to claim 8, further comprising receiving, by a receiver, a further event notification from the S-CSCF, wherein the further event notification comprises a network parameter relating to an IMS Core Network, IMS CN; and
triggering, by the event manager, the event based on the network parameter and the monitored usage.

12. A method according to claim 11, wherein the network parameter relating to the IMS CN indicates a memory utilization within the IMS CN.

13. A method according to claim 12, wherein the update is an update for registration of the one or more UEs and comprises a de-registration of the one or more UEs from die IMS.

14. A method according to claim 8, further comprising receiving, by a receiver, a subscription request from the S-CSCF, the subscription request comprising one or more subscriptions to respective one or more events supported by the S-CSCF; and
setting up, by a subscription manager, a subscription for the S-CSCF to be notified if an event amongst the one or more supported events occurs.

15. (canceled)

16. (canceled)

17. A network node for use as a Serving Call Session Control Function, S-CSCF, in an Internet Protocol Multimedia Subsystem, IMS, the network node comprising:
a receiver configured to receive from an Application Server, AS, an event notification comprising an update on at least one of a network operation and a UE operation for one or more UEs in the IMS, wherein the update is based on a usage by the one or more UEs of a service amongst one or more services offered in the IMS; and
a registration manager configured to trigger an adaptation of the at least one of the network operation and the UE operation based on the received event notification.

18. A network node according to claim 17, wherein the update is an update for registration of the one or more UEs and comprises an update to a re-registration timer for re-registration of the one or more UEs in the IMS network, and wherein the registration manager is configured to update the re-registration timer.

19. A network node according to claim 18, wherein the registration manager is configured to control a transmitter to transmit a message towards the one or more UEs, the message for triggering a re-registration request by the one or more UEs in the IMS,
wherein the receiver is configured to receive a re-registration request originating from the one or more UEs,
and wherein the registration manager is configured to set a new re-registration timer according to the update of the re-registration timer in the event notification and to control a transmitter to transmit a message towards the one or more UEs indicating the new re-registration timer.

20. A network node according to claim 17, further comprising a network parameter manager configured to monitor a network parameter related to an IMS Core Network, IMS CN, and configured to control a transmitter to transmit a further event notification to the AS in dependence on the monitored network parameter meeting one or more criteria.
wherein the further event notification comprises data indicating the monitored network parameter.

21. A network node according to claim 20, wherein the monitored network parameter indicates a memory utilization in the IMS, and wherein the network parameter manager is configured to control the transmitter to transmit the further event notification if the memory utilization rises above a threshold value.

22. A network node according to claim 21, wherein the update is an update for registration of the one or more UEs in the IMS and comprises a de-registration of the one or more UEs, and wherein the registration manager is configured to de-register the one or more UEs from the IMS.

23. A network node according to claim 17, further comprising an event checker configured to control a transmitter to transmit to a Home Subscriber Server, HSS, a request for event data corresponding to an AS,
wherein the receiver is configured to receive the event data from the HSS, the event data identifying one or more events supported by the AS, and
the network node further comprising an event subscriber configured to control the transmitter to transmit a subscription request to the AS, live subscription request comprising one or more subscriptions to the respective one or more events supported by the AS.

24. A method for operating a network node for use as a Serving Call Session Control Function, S-CSCF, in an Internet Protocol Multimedia Subsystem, IMS, the method comprising:
receiving, by a receiver from an Application Server, AS, an operation for one or more UEs in the IMS, wherein the update is based on a usage by the one or more UEs of a service amongst one or more services offered in the IMS; and
triggering, by a registration manager, an adaptation of the at least one of the network operation and the UE operation based on the received event notification.

25.-32. (canceled)

33. A network node for use as a Home Subscriber Server, HSS, in an Internet Protocol Multimedia Subsystem, IMS, the network node comprising:
a receiver configured to receive from a Serving Call Session Control IMS, the event data identifying one or more events supported by the AS; and
an event data manager configured to determine the event data based on the received request and to control a transmitter to transmit the determined event data to the S-CSCF.

34. A network node according to claim 33, wherein the event data manager is configured to identify the one or more events supported by the AS from a list of events stored in the network node per AS basis.

35. A method operating a network node for use as a Home Subscriber Server, HSS, in an Internet Protocol Multimedia Subsystem, IMS, the method comprising:
receiving, by a receiver from a Serving Call Session Control Function, S-CSCF, a request for event data for an Application Server, AS, in the IMS, the event data identifying one or more events supported by the AS;
determining, by an event data manager, the event data based on the received request; and
controlling, by the event data manager, a transmitter to transmit the determined event data to the S-CSCF.

36.-38. (canceled)
